(19) United States
(12) Patent Application Publication
(10) Pub. No.: US 2017/0180738 A1
(43) Pub. Date: Jun. 22, 2017

(54) VIDEO ENCODING/DECODING METHOD AND APPARATUS

(71) Applicant: ELECTRONICS AND TELECOMMUNICATIONS RESEARCH INSTITUTE, Daejeon (KR)

(72) Inventor: Seong Mo PARK, Daejeon (KR)

(21) Appl. No.: 15/217,734

(22) Filed: Jul. 22, 2016

(30) Foreign Application Priority Data
Dec. 17, 2015 (KR) 10-2015-0181056

(51) Int. Cl. H04N 19/159; H04N 19/176; H04N 19/13; H04N 19/124; H04N 19/61; H04N 19/154; H04N 19/132

(52) U.S. Cl. CPC H04N 19/159; H04N 19/154; H04N 19/176; H04N 19/132; H04N 19/124; H04N 19/61; H04N 19/13

(57) ABSTRACT

There is provided a video encoding/decoding method and apparatus. A video encoding method includes determining candidates of a prediction mode on the basis of a quantizer parameter of a block to be currently encoded, comparing rate-distortion costs with respect to the candidates of the prediction mode, thereby selecting an optimal prediction mode among the candidates of the prediction mode, and outputting an encoded bit stream according to the optimal prediction mode.

### CROSS-REFERENCE TO RELATED APPLICATION

The present application claims priority to Korean patent application number 10-2015-0181056 filed on Dec. 17, 2015, the entire disclosure of which is herein incorporated by reference in its entirety.

### BACKGROUND

1. Field

An aspect of the present disclosure relates to a video encoding/decoding method and apparatus.

2. Description of the Related Art

With an increase of demand for contents related to various video services for smart phones, video conferences, surveillance cameras, video storage devices, black boxes, next-generation TVs, and the like, video compression technologies have become technologies getting the spotlight in many industrial fields.

H.264 is a video compression technology that has been jointly developed by Video Coding Experts Group (VCEG) of ITU-T and Moving Picture Experts Group (MPEG) of ISO that are an international moving picture standard establishment group. H.264 is a video compression technology that has been widely used up to now since H.264 was adopted as a standard in 2005. Typically, the VCEG has established the video encoding standard such as H.261, H.263, and H.264, based on a wired communication medium. The MPEG has established the video encoding standard such as MPEG-1 and MPEG-2, for processing video in the storage medium or the broadcast medium. The MPEG has also established MPEG-4 as a video standard over multimedia. The MPEG has realized various functions and a high compression rate by considering object based video coding in the MPEG-4 as important features.

The VCEG of ITU has continuously established the video standard of the high compression rate under the name of H.26L even after the MPEG-4 video standard was established. In the formal comparison experiment of the MPEG, H.26L exhibits superiority larger in terms of the compression rate, as compared with the MPEG-4 video standard (advanced simple profile) having a similar function. Therefore, the MPEG has developed the H.264/AVC that is a JVT video standard together with the VCEG group, using the H.26L.

Recently, the MPEG of ISO/IEC and the VCEG of ITU-T, which have developed H.264/AVC, have set up a joint collaborative team on video coding (JCT-VC), and have completed a draft standard on high efficiency video coding (HEVC) that is a next-generation multimedia video compression technology. HEVC Test Model (HM) version 16.0 was published in August, 2012.

HEVC has achieved a compression rate two times greater than that of the existing H.264/AVC that provided the highest compression rate. HEVC has been developed as a general-purpose moving picture coding technology that can be used in various moving picture resolution environments of almost all transmission media such as a storage medium, the Internet, and satellite broadcasting.

Similarly to the existing video compression technologies, HEVC uses inter-screen prediction, intra-screen prediction, and entropy coding. While H.264 performs coding in units of macro blocks (MBs) as units of 16×16 pixels, HEVC supports a quad-tree coding structure such that blocks of various sizes from 8×8 to 64×64 can be variably used depending on a resolution in the performance of a predicting and transforming operation. In coding based on the quad-tree structure, a block is recursively divided until it reaches from the maximum size to the minimum size depending on a division depth.

In the performance of a predicting operation, a video encoder calculates a rate-distortion cost for a block of the maximum size (e.g., a 64×64 block), and then divides the block to have a size of a lower block (e.g., 32×32 block), thereby calculating a rate-distortion cost of four lower blocks. If the calculation of a rate-distortion cost down to a block (e.g., an 8×8 block) of a size corresponding to a division depth is completed by repeating the processes of calculating the rate-distortion cost and dividing the block, the video encoder determines an optimal block size by comparing the rate-distortion costs of the upper block and the four lower blocks, and performs encoding on a block of the determined size.

This typical method can improve encoding efficiency, but should calculate rate-distortion costs for all blocks from the block of the maximum size to the block of the minimum size. Therefore, the calculation complexity of the video encoder is increased.

In order to solve this, HEVC reference software introduces a high-speed mode determining method for determining a prediction mode (encoding mode) of a block using a high-speed algorithm. Many studies on high-speed determination in HEVC have been conducted to find an optimal intermediate point between a decrease in compression efficiency and an increase in speed.

A bypass coding method based on the degree of interest has recently been proposed as the high-speed mode determining method. The bypass coding method is a method in which, if a bypass condition is satisfied by comparing a value obtained by multiplying a weight of BCU (WBCU) and a rate-distortion rate (COSTINTRA) of a current block in a 2N×2N intra mode with a value obtained by multiplying the WBCU and a rate-distortion rate (COSTSKIP) of the current block in 2N×2N skip mode, the calculation of a rate-distortion cost is stopped at a current depth, and a rate-distortion rate of a smaller block is immediately calculated at a next depth. The bypass coding method has a speed improved by an average of 6% as compared with other high-speed algorithm, but uses a complicated formula. Therefore, the complexity of the bypass coding method is increased in the implementation of hardware, and the bypass coding method is inappropriate in parallel processing.

### SUMMARY

Embodiments provide a video encoding/decoding method and apparatus for determining a prediction mode using a quantizer parameter.

According to an aspect of the present disclosure, there is provided a video encoding method including: determining candidates of a prediction mode on the basis of a quantizer parameter of a block to be currently encoded; selecting an optimal prediction mode among the candidates of the prediction mode by comparing rate-distortion costs of the candidates of the prediction mode; and outputting a bit stream encoded according to the optimal prediction mode.

According to an aspect of the present disclosure, there is provided a video decoding method including: determining candidates of a prediction mode on the basis of a quantizer parameter of a block to be currently decoded; selecting an optimal prediction mode among the candidates of the prediction mode by comparing rate-distortion costs of the candidates of the prediction mode; and outputting a video decoded according to the optimal prediction mode.

According to an aspect of the present disclosure, there is provided a video encoding apparatus including: quantizer parameter to be currently encoded; a prediction module configured to determine candidates of a prediction mode based on the quantizer parameter and select an optimal prediction mode among the candidates of the prediction mode by comparing rate-distortion costs of the candidates of the prediction mode; a transform module configured to transform a residual signal generated by the prediction module and output a transform coefficient; a quantization module configured to quantize the transform coefficient and to output a quantizer coefficient; and an entropy encoding module configured to output a bit stream encoded using a prediction block generated according to the optimal prediction mode and the quantizer coefficient.

According to an aspect of the present disclosure, there is provided a video decoding apparatus including: an entropy decoding module configured to decode a block to be currently decoded, thereby generating a quantizer coefficient; an inverse quantization module configured to inverse quantize the quantizer coefficient, thereby outputting a transform coefficient; an inverse transform module configured to inverse transform the transform coefficient, thereby generating a residual signal; a prediction module configured to determine candidates of a prediction mode on the basis of a quantizer parameter of the block and select an optimal prediction mode among the candidates of the prediction mode by comparing rate-distortion costs with respect to the candidates of the prediction mode; and a filter module configured to output a video filtered using a prediction block generated by the prediction module and the residual signal.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a quad-tree structure supported in high efficiency video coding (HEVC).

FIG. 2 is a diagram illustrating a relationship between prediction units (PUs) and transform units (TUs) with respect to a 2N×2N coding unit (CU).

FIG. 3 is a block diagram illustrating a structure of a video encoding apparatus according to an embodiment of the present disclosure.

FIG. 4 is a block diagram illustrating a structure of a video decoding apparatus according to an embodiment of the present disclosure.

FIG. 5 is a flowchart illustrating a video encoding method according to an embodiment of the present disclosure.

FIG. 6 is a flowchart illustrating in detail the video encoding method according to the embodiment of the present disclosure.

FIG. 7 is a block diagram of a computer system according to an embodiment of the present disclosure.

### DETAILED DESCRIPTION

In the following description, detailed explanation of known related functions and constitutions may be omitted to avoid unnecessarily obscuring the subject manner of the present disclosure.

It will be understood that when an element is referred to as being “connected” or “coupled” to another element, it can be directly connected or coupled to the other element or intervening elements may also be present. In contrast, when an element is referred to as being “directly connected” or “directly coupled” to another element, no intervening elements are present.

It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Furthermore, constitutional parts of the present disclosure are independently shown so as to represent different characteristic functions. Thus, it does not mean that each constitutional part is constituted in a constitutional unit of separated hardware or one software. In other words, each constitutional part includes each of enumerated constitutional parts for convenience of explanation. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present disclosure, if not departing from the essence of the present disclosure.

The terms used in the present application are merely used to describe particular embodiments, and are not intended to limit the present disclosure. Singular forms in the present disclosure are intended to include the plural forms as well, unless the context clearly indicates otherwise.

Hereinafter, exemplary embodiments of the present disclosure will be described in detail with reference to the accompanying drawings.

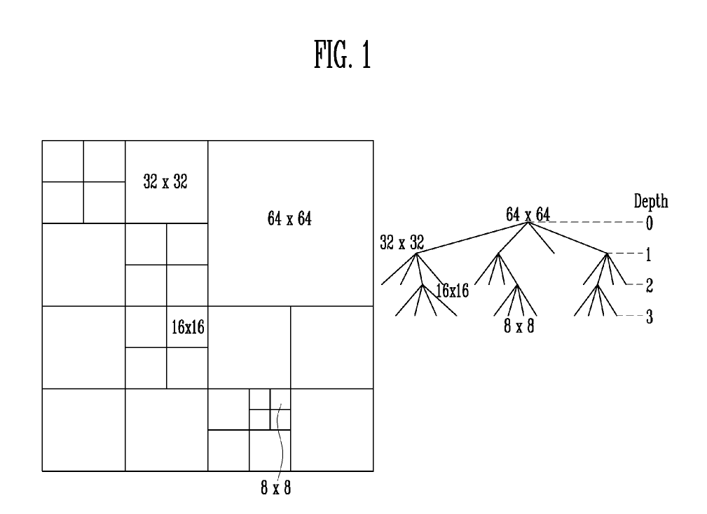

In general, an encoding (or decoding) apparatus performs encoding (or decoding) on an input video (frame). The encoding may be performed for each encoding unit. In high efficiency video coding (HEVC), the encoding unit may be a coding tree unit (CTU), and the CTU includes a coding unit (hereinafter, referred to as CU) that, as shown in FIG. 1, is divided into a quad-tree structure from 64×64 to 8×8 and systematically constructed. As a result, the CU may have sizes of 64×64, 32×32, 16×16, and 8×8. A CU of a larger size than a CU of a specific size may be called as an upper block, and a CU of a smaller size than the CU of the specific size may be called as a lower block. An upper block may be recursively divided into lower blocks.

Each layer of the CTU may have information on a depth (or level). The depth represents a division number and/or degree of the CU, and therefore may include information on a size of the CU. Specifically, as the size of the CU becomes larger, the depth may become smaller. As the size of the CU becomes smaller, the depth may become larger. In HEVC, as shown in FIG. 1, a CTU having a depth of 4 is supported, and a CU of the largest size may be divided into a maximum of 225 blocks.

In the performance of encoding, the encoding apparatus first determines maximum and minimum sizes of a CU depending on a quantizer parameter (hereinafter, referred to as Qp). If the maximum and minimum sizes are determined, a CTU is applied, and a division depth is determined. The division depth may mean a range from a depth corresponding to the maximum size of a block to a size corresponding to the minimum size of the block. In this case, a CU of the largest size at a depth of 0 may be called as a largest coding unit (LCU).

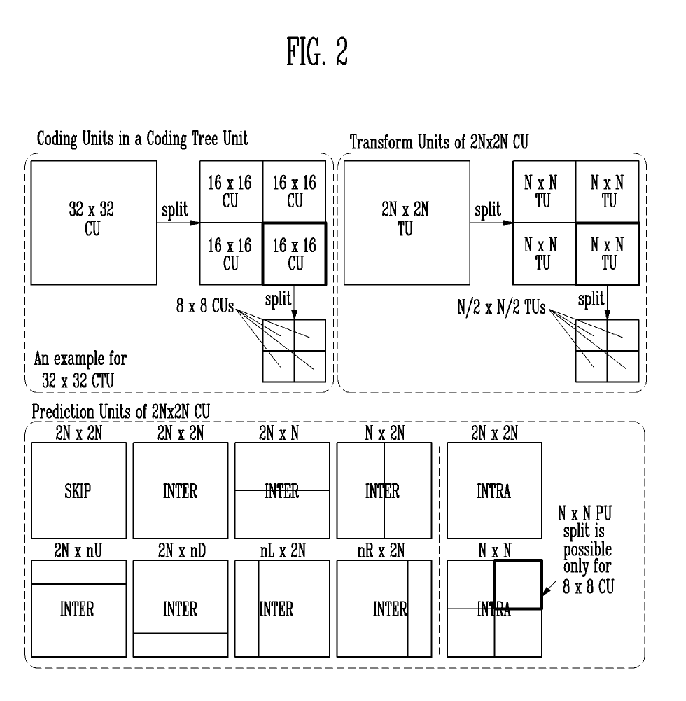

Prediction and transform performed in an encoding process may be performed in units of prediction units (hereinafter, referred to as PUs) and transform units (hereinafter, referred to as TUs), and a relationship between PUs and TUs is the same as shown in FIG. 2. FIG. 2 illustrates an example when a CTU has a size of 32×32. In this case, available sizes of division blocks are 32×32, 16×16, and 8×8.

As shown in FIG. 2, when a CU is in a 2N×2N mode, a PU may be in one mode selected from a 2N×2N skip mode, a 2N×2N inter mode, a 2N×N inter mode, an N×2N inter mode, a 2N×2N intra mode, and an N×N intra mode. In various embodiments, the PU may be in one mode selected from a 2N×nU mode, a 2N×nD mode, an nL×2N mode, and an nR×2N mode. The encoding apparatus performs a prediction operation according to the selected PU mode (prediction mode or encoding mode).

A TU is a unit of a transform operation for transforming a residual signal generated in a process of performing a prediction operation. The TU is determined regardless of the form of the PU as shown in FIG. 2. Accordingly, the transform of the TU can be performed on a residual signal passing through the boundary of the PU. In the embodiment of FIG. 2, the TU is divided along a quad-tree, and is transformed from 32×32 to 4×4.

When a PU (or a prediction mode) is selected in a typical method, an encoding apparatus calculates a rate-distortion cost while recursively dividing a CU until it reaches from the maximum size to the minimum size depending on a division depth, and selects a prediction mode in which the rate-distortion cost becomes smallest. Specifically, in FIG. 2, the encoding apparatus calculates a rate-distortion cost of a 32×32 unit for each prediction mode, and then divides the unit into lower blocks (16×16), thereby calculating a rate-distortion cost of four lower blocks for each prediction mode. If the calculation of a rate-distortion cost down to a block (8×8) of the smallest size is completed by repeating the processes of calculating the rate-distortion cost and dividing the block, the video encoding apparatus determines, as a PU, a block of which rate-distortion cost becomes smallest by comparing the calculated rate-distortion costs, and performs prediction in a mode of the determined PU.

This typical method can improve encoding efficiency, but necessarily calculates rate-distortion costs for all blocks from the block of the maximum size to the block of the minimum size. Therefore, the calculation complexity of the video encoding apparatus is increased. Accordingly, a high-speed mode determining method for determining an optimal prediction mode at high speed has recently developed. The high-speed mode determining method provides a high-speed algorithm that can stop division of a CU into lower blocks and calculation of a rate-distortion cost during the division of the CU and the calculation of a rate-distortion cost.

As an example, in an early CU determination algorithm determined by an early coding unit (ECU), when the skip mode in a CU of a current size is determined as an optimal prediction mode, a rate-distortion cost of a next depth is not calculated by dividing the CU into lower blocks, and the determination of a prediction mode in the CU of the current size is ended. For example, when a rate-distortion cost in the skip mode of a 64×64 PU within a CU of a size of 64×64 is smaller than that calculated in a 64×32 PU or 32×64 PU, the determination of a prediction mode is ended at a depth of the 64×64 PU, and it is unnecessary to calculate a rate-distortion cost of a PU of a smaller size. However, the early CU determination algorithm based on the ECU is not appropriate in encoding of a video having unequal quality and complicated movement.

In order to solve this, a bypass coding method based on the degree of interest has recently been proposed. However, as described above, the complexity of the bypass coding method is increased in the implementation of hardware, and the bypass coding method is inappropriate in parallel processing.

Accordingly, in the present disclosure, there is provided a method for determining a prediction mode early, which is simply implemented using a Qp and facilitates parallel processing. Hereinafter, an encoding/decoding method and apparatus for performing prediction according to the prediction mode determining method of the present disclosure.

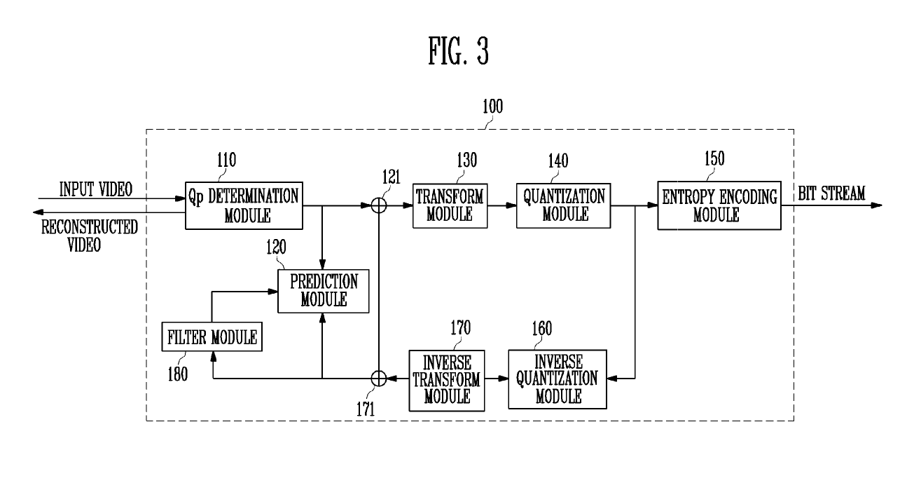

FIG. 3 is a block diagram illustrating a structure of a video encoding apparatus according to an embodiment of the present disclosure.

Referring to FIG. 3, the video encoding apparatus 100 may include a quantizer parameter determination module 110, a prediction module 120, a transform module 130, a quantization module 140, an entropy encoding module 150, an inverse quantization module 160, an inverse transform module 170, and a filter module 180.

The quantizer parameter determination module 110 determines a Qp of a current CU. The Qp is a parameter used when coefficients generated by orthogonally transforming an arbitrary block are quantized. The quantizer parameter determination module 110 may determine a basic Qp of a CU using a preset Qp determination algorithm. For example, the quantizer parameter determination module 110 may determine a Qp corresponding to the size of a PU or TU. Specifically, the quantizer parameter determination module 110 determines the basic Qp, and may exponentially increase the Qp as the size of the PU or TU decreases. This algorithm is merely an example of the method for determining the Qp, and the present disclosure is not particularly limited to the method for determining the Qp.

The prediction module 120 determines a prediction mode and generates a prediction block according to the prediction mode. To determine a prediction mode is determined may mean to select an optimal PU (optimal PU size) and select a prediction mode corresponding to the selected size.

The prediction module 120 determines whether an optimal prediction method of a current PU is inter prediction or intra prediction, and may set a specific mode of each prediction method. A skip mode, a merge mode, or a motion vector prediction (MVP) may be used in the inter prediction, and 33 directional prediction modes and at least two non-directional modes may be used in the intra prediction. The non-directional mode may include a DC prediction mode and a planar mode. The prediction module 120 may include an inter prediction module and an intra prediction module so as to perform prediction according to the respective modes.

The inter prediction module generates a motion vector through motion estimation in a previous frame (reference video) that has already passed through an encoding process and been reconstructed, and generates, through a motion compensating process using the motion vector, a prediction block in which a residual signal with the current PU is minimized and the magnitude of the motion vector is also minimized. The inter prediction module may include a motion prediction module and a motion compensation module. Information on an index, a motion vector (e.g., a motion vector predictor), and a residual signal of a reference video selected through the inter prediction may be entropy-encoded and transmitted to a decoding apparatus. When the skip mode is applied, the prediction block may be used as a reconstructed block. Therefore, the residual signal may not be generated, transformed, quantized, or transmitted.

The intra prediction module determines a prediction mode using information on a peripheral CU that has already passed through an encoding process and been reconstructed, and generates a prediction block using the determined prediction mode. Information on an intra prediction mode selected through the intra prediction may be entropy-encoded and transmitted to the decoding apparatus.

In various embodiments, the prediction module 120 may determine a prediction mode depending on a Qp. The prediction module 120 determines candidates of the prediction mode depending on Qp values, and may determine an optimal prediction mode among the candidates of the prediction mode.

Specifically, if the Qp is greater than a first threshold value, the prediction module 120 may determine whether the skip mode or the merge mode is applied to a current CU. If the skip mode or the merge mode is applied to the current CU, the prediction module 120 may generate a prediction block by performing prediction according to the skip mode or the merge mode. If the skip mode and the merge mode are not applied, the prediction module 120 determines a 2N×2N inter mode and an intra mode as candidates of the prediction mode with respect to the current CU, and may determine, as an optimal prediction mode, a prediction mode in which the rate-distortion cost of the current CU becomes smallest among the modes. In various embodiments, the first threshold value may be 30.

If the Qp is smaller than or equal to the first threshold value and greater than a second threshold value, the prediction module 120 may determine whether the skip mode or the merge mode is applied to the current CU. If the skip mode or the merge mode is applied to the current CU, the prediction module 120 determines the 2N×2N inter mode and the intra mode as candidates of the prediction mode with respect to the current CU after the merge mode is performed, and may determine, as an optimal prediction mode, a prediction mode in which the rate-distortion cost of the current CU becomes smallest among the modes. If the skip mode and the merge mode are not applied, the prediction module 120 determines the 2N×2N inter mode, an N×2N inter mode, a 2N×N inter mode, and the intra mode as candidates of the prediction mode with respect to the current CU, and may determine, as an optimal prediction mode, a prediction mode in which the rate-distortion cost of the current CU becomes smallest among the modes. In various embodiments, the second threshold value may be 25.

If the Qp is smaller than or equal to the second threshold value, the prediction module 120 may determine whether the skip mode or the merge mode is applied to the current CU. If the skip mode or the merge mode is applied to the current CU, the prediction module 120 determines the 2N×2N inter mode, the N×2N inter mode, the 2N×N inter mode, and the intra mode as candidates of the prediction mode with respect to the current CU, and may determine, as an optimal prediction mode, a prediction mode in which the rate-distortion cost of the current CU becomes smallest among the modes. If the skip mode or the merge mode is not applied, the prediction module 120 determines the 2N×2N inter mode, the N×2N inter mode, the 2N×N inter mode, an inter AMP mode, and the intra mode as candidates of the prediction mode with respect to the current CU, and may determine, as an optimal prediction mode, a prediction mode in which the rate-distortion cost of the current CU becomes smallest among the modes.

The prediction module 120 may perform prediction according to the optimal prediction mode determined according to the above-described embodiments, thereby generating a prediction block.

The generated prediction block and the original block are transmitted to a subtractor 121, and a residual signal (or a residual block or value) between the prediction block and the original block may be transmitted to the transform module 130 through the subtractor 121. When the prediction module 120 generates a prediction block of a PU in the skip mode, the residual signal may not be transmitted to the transform module 130.

The transform module 130 may perform transform on the residual signal, thereby outputting a transform coefficient. The transform module 130 may perform transform in unit of Tus, and the size of a TU is equal to or smaller than that of a corresponding CU. The size of the TU is irrelevant to that of a corresponding PU. The transform module 130 may transform the residual signal using discrete cosine transform (DCT) and/or discrete sine transform (DST).

The quantization module 140 may quantize an input transform coefficient on the basis of the Qp, thereby outputting a quantized coefficient.

The entropy encoding module 150 may perform entropy encoding on the quantized coefficient generated by the quantization module 140, thereby outputting a bit stream. The entropy encoding module 150 may encodes values calculated in an encoding process, e.g., a variety of information such as block type information, prediction mode information, dividing unit information, PU information, TU information, motion vector information, reference video information, block interpolation information, and filtering information. The entropy encoding may include encoding methods such as an exponential golomb method, a context-adaptive variable length coding (CAVLC) method, and a context-adaptive binary arithmetic coding (CABAC) method.

The video encoding apparatus 100 of FIG. 3 performs inter prediction, and therefore, a current encoded video is necessarily decoded and stored to be used as a reference video. Accordingly, the quantized coefficient is inverse-quantized by the inverse quantization module 160, and is inverse-transformed by the inverse transform module 170. The inverse-quantized and inverse-transformed coefficient becomes a reconstructed residual signal to be combined with the prediction block through an adder 171, thereby generating a reconstructed block.

The reconstructed block passes through the filter module 180, and the filter module 180 may apply, to a reconstructed block or a reconstructed picture, at least one a deblocking filter, a sample adaptive offset (SAO), and an adaptive loop filter (ALF). The reconstructed block passing through the filter module 180 may be stored in a reference video buffer.

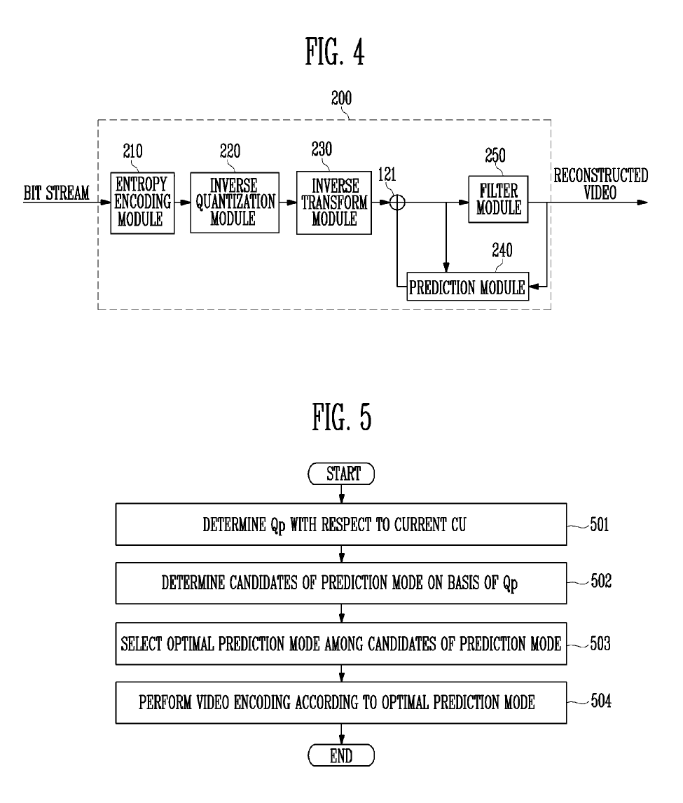

FIG. 4 is a block diagram illustrating a structure of a video decoding apparatus according to an embodiment of the present disclosure.

Referring to FIG. 4, the video decoding apparatus 200 according to the embodiment of the present disclosure may include an entropy decoding module 210, an inverse quantization module 220, an inverse transform module 230, a prediction module 240, and a filter module 250.

The video decoding apparatus 200 may receive a bit stream output from the image encoding apparatus 100 to perform decoding on the bit stream in an intra mode or an inter mode and output a reconstructed video, i.e., a reconstructed video. The image decoding apparatus 200 may acquire a reconstructed residual block from the received bit stream, generate a prediction block and then add the reconstructed residual block and the prediction block, thereby generating a reconfigured block, i.e., a reconstructed block.

The entropy decoding module 210 may perform entropy decoding on the received bit stream according to a probability distribution, thereby generating symbols including a quantized coefficient type symbol. The entropy decoding method is similar to the above-described entropy encoding method.

The quantized coefficient is inverse-quantized by the inverse quantization module 220 using a quantizer parameter, and is inverse-transformed by the inverse transform module 230. As the quantized coefficient is inverse-quantized/inverse-transformed, a reconstructed residual block may be generated.

The prediction module 240 performs prediction according to the intra mode or the inter mode, thereby generating a prediction block. In various embodiments, the prediction module 240 may determine a prediction mode depending on a Qp, which has been described above. To this end, the prediction module 240 may include a quantizer parameter determination module similar to that of the video encoding apparatus 100, or may receive a quantizer parameter value from a quantizer parameter determination module (not shown) configured separately therefrom.

The reconstructed residual block and the prediction block are added through an adder 241, and at least one of the deblocking filter, the SAO, and the ALF may be applied to the added block through the filter module 250. The filter module 250 may output a reconfigured video, i.e., a reconstructed video.

Hereinafter, a video encoding method of the video encoding apparatus and a video decoding method of the video decoding apparatus will be described in detail. Although a method for determining an optimal prediction mode in video encoding is mainly described, it is obvious that the method may be applied to video decoding, and therefore, the video decoding method is omitted. However, the following video encoding method has the same scope as the video decoding method without departing from the spirit and scope of the present disclosure.

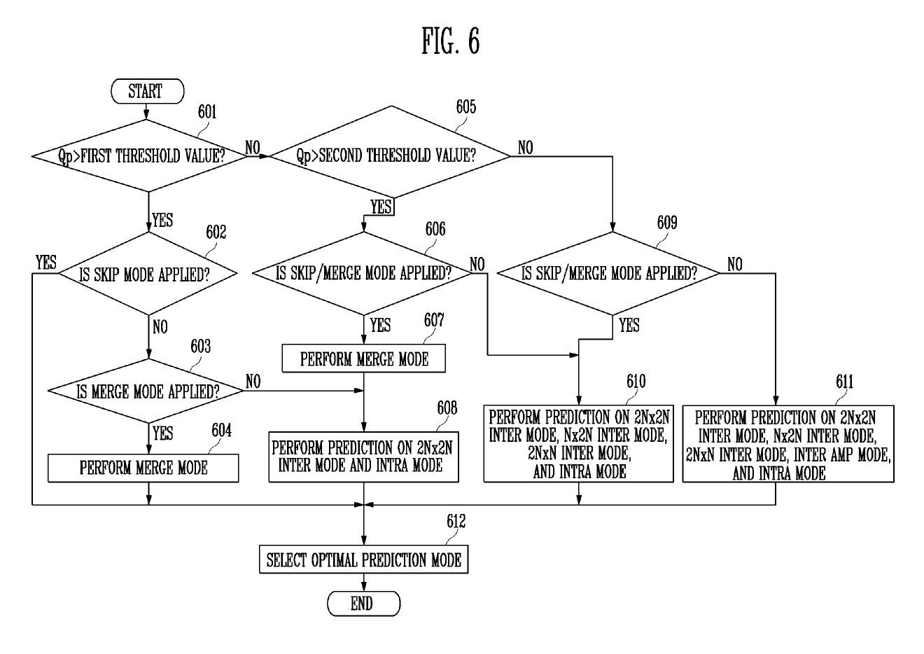

FIG. 5 is a flowchart illustrating a video encoding method according to an embodiment of the present disclosure.

Referring to FIG. 5, a video encoding apparatus determines a Qp with respect to a current CU (501).

The video encoding apparatus may determine the Qp with respect to the current CU according to a preset algorithm. The Qp may be determined based on a size, a resolution, etc. of the current CU, and the determination method is not limited.

Next, the video encoding apparatus may determine candidates of a prediction mode on the basis of the Qp (502). When the Qp is greater than a first threshold value, the video encoding apparatus determines whether a skip mode or a merge mode is applied to the current CU. Then, if the skip mode and the merge mode are not applied, the video encoding apparatus may determine a 2N×2N inter mode and an intra mode as the candidates of the prediction mode. In various embodiments, the first threshold value may be 30.

When the Qp is smaller than the first threshold value and greater than a second threshold value, the video encoding apparatus, based on whether the skip mode or the merge mode is applied to the current CU, may determine the 2N×2N inter mode and the intra mode as candidates of the prediction mode, or may determine the 2N×2N inter mode, an N×2N inter mode, a 2N×N inter mode, and the intra mode as candidates of the prediction mode. In various embodiments, the second threshold value may be 25.

When the Qp is smaller than or equal to the second threshold value, the video encoding apparatus, based on whether the skip mode or the merge mode is applied to the current CU, may determine the 2N×2N inter mode, the N×2N inter mode, the 2N×N inter mode, and the intra mode as candidates of the prediction mode, or may determine the 2N×2N inter mode, the N×2N inter mode, the 2N×N inter mode, an inter AMP mode, and the intra mode as candidates of the prediction mode.

When the candidates of the prediction mode are determined, the number or set of threshold values and the candidates of the prediction mode according to the threshold values may be variously applied, modified, and changed without departing from the spirit and scope of the present disclosure, and it is obvious that the changed embodiments may also belong to the scope of the present disclosure.

Next, the video encoding apparatus selects an optimal prediction mode among the determined candidates of the prediction mode (503).

In a case where the skip mode or the merge mode is not applied to the current CU, the optimal prediction mode may be the skip mode or the merge mode. In another case, a prediction mode in which the rate-distortion cost of the current CU becomes smallest among the candidates of the prediction mode may be selected as the optimal prediction mode.

If the optimal prediction mode is determined, the video encoding apparatus perform video encoding according to the optimal prediction mode (504).

Hereinafter, in the above-described embodiment, the method for determining the candidates of the prediction mode on the basis of the Qp and determining the optimal prediction mode will be described in detail.

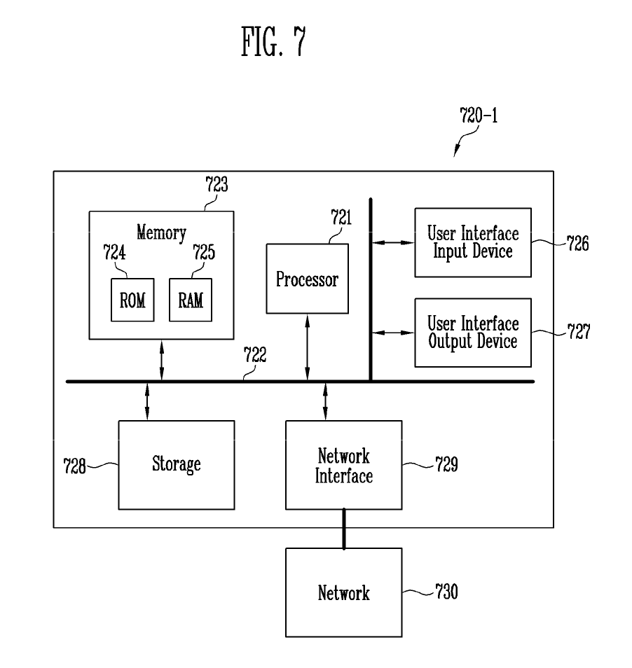

FIG. 6 is a flowchart illustrating in detail the video encoding method according to the embodiment of the present disclosure.

Referring to FIG. 6, the video encoding apparatus determines whether the Qp is greater than the first threshold value (601).

If the Qp is greater than the first threshold value, the video encoding apparatus determines whether the skip mode is applied to the current CU (602). In an embodiment, the video encoding apparatus may determine whether the skip mode is applied to the current CU by using a coded block flag (CBF) fast mode (CFB) using a motion vector of a 2N×2N inter mode and a CBF. For example, if the motion vector of the current CU is 0 and both the CBFs of uma and chroma are 0, it may be determined that the skip mode is applied to the current CU. However, the determining of whether the skip mode is applied to the current CU is not limited to the above-described method, and may be performed according to various algorithms.

If the skip mode is applied to the current CU, the video encoding apparatus immediately selects an optimal prediction mode (612). In this case, the optimal prediction mode may be selected as the skip mode.

If the skip mode is not applied to the current CU, the video encoding apparatus determines whether the merge mode is applied to the current CU (603). In an embodiment, the video encoding apparatus may determine whether the merge mode is applied to the current CU by using the CBF, which has been described above. However, as described above, the determining of whether the merge mode is applied to the current CU is not particularly limited.

If the merge mode is applied to the current CU, the video encoding apparatus performs the merge mode (604), and selects an optimal prediction mode (612). That is, the video encoding apparatus may determine only the merge mode as a candidate of the prediction mode and select the merge mode as an optimal prediction mode.

If the merge mode is not applied to the current CU, the video encoding apparatus determines the 2N×2N inter mode and the intra mode as candidates of the prediction mode, and perform prediction on the 2N×2N inter mode and the intra mode (608). The video encoding apparatus may compare rate-distortion costs respectively obtained by performing prediction on the 2N×2N inter mode and the intra mode, thereby determining an optimal prediction mode among the modes (612).

Meanwhile, if the Qp is not greater than the first threshold value, the video encoding apparatus determines whether the Qp is greater than the second threshold value (605).

If the Qp is greater than the second threshold value, the video encoding apparatus determines whether the skip mode or the merge mode is applied to the current CU (606). The determining of whether the skip mode or the merge mode is applied to the current CU is the same as described above.

If the skip mode or the merge mode is applied to the current CU, the video encoding apparatus determines the 2N×2N inter mode and the intra mode as candidates of the prediction mode. The video encoding apparatus performs the merge mode (607), and performs prediction on the 2N×2N inter mode and the intra mode (608). The video encoding apparatus may compare rate-distortion costs respectively obtained by performing prediction on the merge mode, the 2N×2N inter mode and the intra mode, thereby determining an optimal prediction mode among the modes (612).

If the skip mode and the merge mode are not applied to the current CU, the video encoding apparatus determines the 2N×2N inter mode, the N×2N inter mode, the 2N×N inter mode, and the intra mode as candidates of the prediction mode, and performs prediction on the 2N×2N inter mode, the N×2N inter mode, the 2N×N inter mode, and the intra mode (610). The video encoding apparatus may compare rate-distortion costs respectively obtained by performing prediction on the 2N×2N inter mode, the N×2N inter mode, the 2N×N inter mode, and the intra mode, thereby determining an optimal prediction mode among the modes (612).

Meanwhile, if the Qp is not greater than the second threshold value, the video encoding apparatus determines whether the skip mode or the merge mode is applied to the current CU (609). The determining of whether the skip mode or the merge mode is applied to the current CU is the same as described above.

If the skip mode or the merge mode is applied to the current CU, the video encoding apparatus determines the 2N×2N inter mode, the N×2N inter mode, the 2N×N inter mode, and the intra mode as candidates of the prediction mode, and performs prediction on the 2N×2N inter mode, the N×2N inter mode, the 2N×N inter mode, and the intra mode (610). The video encoding apparatus may compare rate-distortion costs respectively obtained by performing prediction on the 2N×2N inter mode, the N×2N inter mode, the 2N×N inter mode, and the intra mode, thereby determining an optimal prediction mode among the modes (612).

If the skip mode and the merge mode are not applied to the current CU, the video encoding apparatus determines the 2N×2N inter mode, the N×2N inter mode, the 2N×N inter mode, the inter AMP mode, and the intra mode as candidates of the prediction mode, and performs prediction on the 2N×2N inter mode, the N×2N inter mode, the 2N×N inter mode, the inter AMP mode, and the intra mode (611). The video encoding apparatus may compare rate-distortion costs respectively obtained by performing prediction on the 2N×2N inter mode, the N×2N inter mode, the 2N×N inter mode, the inter AMP mode, and the intra mode, thereby determining an optimal prediction mode among the modes (612).

An embodiment of the present invention may be implemented in a computer system, e.g., as a computer readable medium. As shown in FIG. 7, a computer system 720-1 may include one or more of a processor 721, a memory 723, a user input device 726, a user output device 727, and a storage 728, each of which communicates through a bus 722. The computer system 720-1 may also include a network interface 729 that is coupled to a network 730. The processor 721 may be a central processing unit (CPU) or a semiconductor device that executes processing instructions stored in the memory 723 and/or the storage 728. The memory 723 and the storage 728 may include various forms of volatile or non-volatile storage media. For example, the memory may include a read-only memory (ROM) 724 and a random access memory (RAM) 725.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to the present disclosure, the video encoding/decoding method and apparatus according to the present disclosure can be simply implemented, facilitate parallel processing in a system on chip (SoC) implementation, and increase the speed of encoding/decoding.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A video encoding method comprising:
determining candidates of a prediction mode on the basis of a quantizer parameter of a block to be currently encoded;
selecting an optimal prediction mode among the candidates of the prediction mode by comparing rate-distortion costs of the candidates of the prediction mode; and
outputting a bit stream encoded according to the optimal prediction mode.

2. The video encoding method of claim 1, wherein the determining of the candidates of the prediction mode includes, when the quantizer parameter is greater than a first threshold value, determining whether a skip mode is applied to the block, and
the selecting of the optimal prediction mode includes, if the skip mode is applied to the block, selecting the skip mode as the optimal prediction mode.

3. The video encoding method of claim 2, wherein the determining of the candidates of the prediction mode includes, if the skip mode is not applied to the block, determining whether a merge mode is applied to the block, and
the selecting of the optimal prediction mode includes, if the merge mode is applied to the block, selecting the merge mode as the optimal prediction mode.

4. The video encoding method of claim 2, wherein the determining of the candidates of the prediction mode includes, if the merge mode is not applied to the block, determining at least one of a 2N×2N inter mode and an intra mode as the candidates of the prediction mode, and
the selecting of the optimal prediction mode includes comparing rate-distortion costs of at least one of the 2N×2N inter mode and the intra mode, thereby selecting the optimal prediction mode.

5. The video encoding method of claim 2, wherein the determining of the candidates of the prediction mode includes:
when the quantizer parameter is not greater than the first threshold value and is greater than a second threshold value, determining whether the skip mode or the merge mode is applied to the block;
if the skip mode or the merge mode is applied to the block, determining at least one of the merge mode, the 2N×2N inter mode, and the intra mode as the candidates of the prediction mode; and
if the skip mode and the merge mode are not applied to the block, determining at least one of the 2N×2N inter mode, an N×2N inter mode, a 2N×N inter mode, and the intra mode as the candidates of the prediction mode.

6. The video encoding method of claim 5, wherein the determining of the candidates of the prediction mode includes:
when the quantizer parameter is not greater than the second threshold value, determining whether the skip mode or the merge mode is applied to the block;
if the skip mode or the merge mode is applied to the block, determining at least one of the 2N×2N inter mode, the N×2N inter mode, the 2N×N inter mode, and the intra mode as the candidates of the prediction mode; and
if the skip mode and the merge mode are not applied to the block, determining at least one of the 2N×2N inter mode, the N×2N inter mode, the 2N×N inter mode, an inter AMP mode, and the intra mode as candidates of the prediction mode.

7. A video decoding method comprising:
determining candidates of a prediction mode on the basis of a quantizer parameter of a block to be currently decoded;
selecting an optimal prediction mode among the candidates of the prediction mode by comparing rate-distortion costs of the candidates of the prediction mode; and
outputting a video decoded according to the optimal prediction mode.

8. The video decoding method of claim 7, wherein the determining of the candidates of the prediction mode includes, when the quantizer parameter is greater than a first threshold value, determining whether a skip mode is applied to the block, and
the selecting of the optimal prediction mode includes, if the skip mode is applied to the block, selecting the skip mode as the optimal prediction mode.

9. The video decoding method of claim 8, wherein the determining of the candidates of the prediction mode includes, if the skip mode is not applied to the block, determining whether a merge mode is applied to the block, and
the selecting of the optimal prediction mode includes, if the merge mode is applied to the block, selecting the merge mode as the optimal prediction mode.

10. The video decoding method of claim 8, wherein the determining of the candidates of the prediction mode includes, if the merge mode is not applied to the block, determining at least one of a 2N×2N inter mode and an intra mode as the candidates of the prediction mode, and
the selecting of the optimal prediction mode includes comparing rate-distortion costs of at least one of the 2N×2N inter mode and the intra mode, thereby selecting the optimal prediction mode.

11. The video decoding method of claim 8, wherein the determining of the candidates of the prediction mode includes:
when the quantizer parameter is not greater than the first threshold value and is greater than a second threshold value, determining whether the skip mode or the merge mode is applied to the block;
if the skip mode or the merge mode is applied to the block, determining at least one of the merge mode, the 2N×2N inter mode, and the intra mode as the candidates of the prediction mode; and
if the skip mode and the merge mode are not applied to the block, determining at least one of the 2N×2N inter mode, an N×2N inter mode, a 2N×N inter mode, and the intra mode as the candidates of the prediction mode.

12. The video decoding method of claim 11, wherein the determining of the candidates of the prediction mode includes:
when the quantizer parameter is not greater than the second threshold value, determining whether the skip mode or the merge mode is applied to the block;
if the skip mode or the merge mode is applied to the block, determining at least one of the 2N×2N inter mode, the N×2N inter mode, the 2N×N inter mode, and the intra mode as the candidates of the prediction mode; and
if the skip mode and the merge mode are not applied to the block, determining at least one of the 2N×2N inter mode, the N×2N inter mode, the 2N×N inter mode, an inter AMP mode, and the intra mode as candidates of the prediction mode.

13. A video encoding apparatus comprising:
a quantizer parameter determination module configured to determine a quantizer parameter to be currently encoded;
a prediction module configured to determine candidates of a prediction mode based on the quantizer parameter and select an optimal prediction mode among the candidates of the prediction mode by comparing rate-distortion costs of the candidates of the prediction mode;
a transform module configured to transform a residual signal generated by the prediction module and output a transform coefficient;
a quantization module configured to quantize the transform coefficient and to output a quantizer coefficient; and
an entropy encoding module configured to output a bit stream encoded using a prediction block generated according to the optimal prediction mode and the quantizer coefficient.

14. The video encoding apparatus of claim 13, wherein the prediction module, if the quantizer parameter is greater than a first threshold value, determines whether a skip mode is applied to the block, if the skip mode is applied to the block, selects the skip mode as the optimal prediction mode, if the skip mode is not applied to the block, determines whether a merge mode is applied to the block, if the merge mode is applied to the block, selects the merge mode as the optimal prediction mode, if the merge mode is not applied to the block, determines at least one of a 2N×2N inter mode and an intra mode as the candidates of the prediction mode, and compares rate-distortion costs with respect to at least one of the 2N×2N inter mode and the intra mode, thereby selecting the optimal prediction mode.

15. The video encoding apparatus of claim 14, wherein the prediction module, if the quantizer parameter is not greater than the first threshold value and is greater than a second threshold value, determines whether the skip mode or the merge mode is applied to the block, if the skip mode or the merge mode is applied to the block, determines at least one of the merge mode, the 2N×2N inter mode, and the intra mode as the candidates of the prediction mode, and, if the skip mode and the merge mode are not applied to the block, at least one of the 2N×2N inter mode, an N×2N inter mode, a 2N×N inter mode, and the intra mode as the candidates of the prediction mode.

16. The video encoding apparatus of claim 15, wherein the prediction module, when the quantizer parameter is not greater than the second threshold value, determines whether the skip mode or the merge mode is applied to the block, if the skip mode or the merge mode is applied to the block, determines at least one of the 2N×2N inter mode, the N×2N inter mode, the 2N×N inter mode, and the intra mode as the candidates of the prediction mode, and, if the skip mode and the merge mode are not applied to the block, determines at least one of the 2N×2N inter mode, the N×2N inter mode, the 2N×N inter mode, an inter AMP mode, and the intra mode as candidates of the prediction mode.

17. A video decoding apparatus comprising:
an entropy decoding module configured to decode a block to be currently decoded, thereby generating a quantizer coefficient;
an inverse quantization module configured to inverse quantize the quantizer coefficient, thereby outputting a transform coefficient;
an inverse transform module configured to inverse transform the transform coefficient, thereby generating a residual signal;
a prediction module configured to determine candidates of a prediction mode on the basis of a quantizer parameter of the block and select an optimal prediction mode among the candidates of the prediction mode by comparing rate-distortion costs with respect to the candidates of the prediction mode; and
a filter module configured to output a video filtered using a prediction block generated by the prediction module and the residual signal.

18. The video decoding apparatus of claim 17, wherein the prediction module, if the quantizer parameter is greater than a first threshold value, determines whether a skip mode is applied to the block, if the skip mode is applied to the block, selects the skip mode as the optimal prediction mode, if the skip mode is not applied to the block, determines whether a merge mode is applied to the block, if the merge mode is applied to the block, selects the merge mode as the optimal prediction mode, if the merge mode is not applied to the block, determines at least one of a 2N×2N inter mode and an intra mode as the candidates of the prediction mode, and compares rate-distortion costs with respect to at least one of the 2N×2N inter mode and the intra mode, thereby selecting the optimal prediction mode.

19. The video decoding apparatus of claim 18, wherein the prediction module, if the quantizer parameter is not greater than the first threshold value and is greater than a second threshold value, determines whether the skip mode or the merge mode is applied to the block, if the skip mode or the merge mode is applied to the block, determines at least one of the merge mode, the 2N×2N inter mode, and the intra mode as the candidates of the prediction mode, and, if the skip mode and the merge mode are not applied to the block, at least one of the 2N×2N inter mode, an N×2N inter mode, a 2N×N inter mode, and the intra mode as the candidates of the prediction mode.

20. The video decoding apparatus of claim 19, wherein the prediction module, when the quantizer parameter is not greater than the second threshold value, determines whether the skip mode or the merge mode is applied to the block, if the skip mode or the merge mode is applied to the block, determines at least one of the 2N×2N inter mode, the N×2N inter mode, the 2N×N inter mode, and the intra mode as the candidates of the prediction mode, and, if the skip mode and the merge mode are not applied to the block, determines at least one of the 2N×2N inter mode, the N×2N inter mode, the 2N×N inter mode, an inter AMP mode, and the intra mode as candidates of the prediction mode.
